(19) United States
(12) Patent Application Publication
(10) Pub. No.: US 2002/0134479 A1
(43) Pub. Date: Sep. 26, 2002

(54) Tire breaker for vehicle tire

(76) Inventor: Shut Chen Hsu, I Lan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/813,850

(22) Filed: Mar. 22, 2001

(51) Int. Cl. B60C 5/02

(52) U.S. Cl. 152/510; 152/531; 152/526

(57) ABSTRACT

A tire breaker having and an annular body fitting over the periphery of the inner tube of a vehicle tire and adapted to protect the inner tube of the vehicle tire against piercing of external sharp objects, the annular body having a corrugated outside wall.

### BACKGROUND OF THE INVENTION

The present invention relates to vehicle tires and, more specifically, to a tire breaker for vehicle tire, which protects the tire against piercing of external sharp objects.

A motor vehicle is an important transportation device to many people in every city in the world. A fatal accident may occur if one tire of the vehicle explodes during driving. For a safety driving, the condition of the tires of the motor vehicle must be regularly checked. However, regular vehicle tires cannot effectively protect against piercing of an external sharp object. When a nail or the like pierced through the tire of a running motor vehicle, a tire explosion may occur.

### SUMMARY OF THE INVENTION

The present invention has been accomplished to provide a tire breaker for vehicle tire, which protects the tire against piercing of an external sharp object. It is another object of the present invention to provide a tire breaker for vehicle tire, which fits different sizes of tires. It is still another object of the present invention to provide a tire breaker for vehicle tire, which is easy to install. According to one embodiment of the present invention, the tire breaker has an annular shape fitting over the periphery of the inner tube of a vehicle tire and adapted to protect the inner tube of the vehicle tire against piercing of external sharp objects, and a corrugated outside wall. According to another embodiment of the present invention, a flexible covering is provided and covered on the body of the tire breaker.

### BRIEF DESCRIPTION OF THE DRAWINGS

FIG. 1 illustrates a tire breaker for vehicle tire constructed according to a first embodiment of the present invention.

FIG. 2 illustrates a tire breaker for vehicle tire constructed according to a second embodiment of the present invention.

FIG. 3(a) is a front view showing a tire breaker without through holes according to the present invention.

FIG. 3(b) is a front view showing a tire breaker with a series of through holes according to the present invention.

FIG. 3(c) is a front view showing a tire breaker with two parallel series of through holes according to the present invention.

FIG. 3(d) is a front view showing a tire breaker with three parallel series of through holes according to the present invention.

FIG. 4 is a side plain view of the tire breaker shown in FIG. 2.

FIG. 5 is an enlarged view of a part of FIG. 4.

FIG. 6 is a sectional view showing a tire breaker installed in the vehicle tire according to one embodiment of the present invention.

FIG. 7 is a sectional view showing a tire breaker installed in the vehicle tire according another embodiment of the present invention.

FIG. 8 illustrates three tire breakers arranged in parallel and peripherally partially overlapped on one another according to the present invention.

FIG. 9 illustrates a tire breaker for vehicle tire constructed according to a third embodiment of the present invention.

FIG. 10 is a sectional view showing a tire breaker installed in the vehicle tire according to still another embodiment of the present invention.

### DETAILED DESCRIPTION OF THE PREFERRED EMBODIMENT

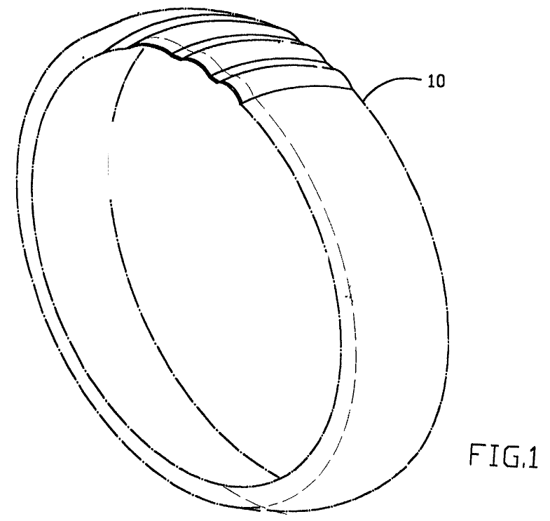

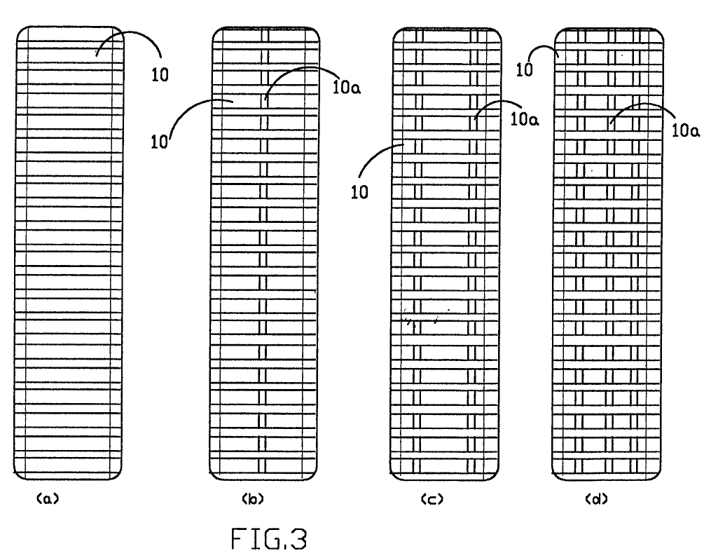

Referring to FIGS. 1 and 3a, the tire breaker, referenced by 10, is made of flexible material and adapted to protect the inner tube of a vehicle tire against piercing of external sharp objects. The tire breaker 10 has an annular shape fitting the periphery of the inner tube of any of a variety of vehicle tires, and corrugated outside wall.

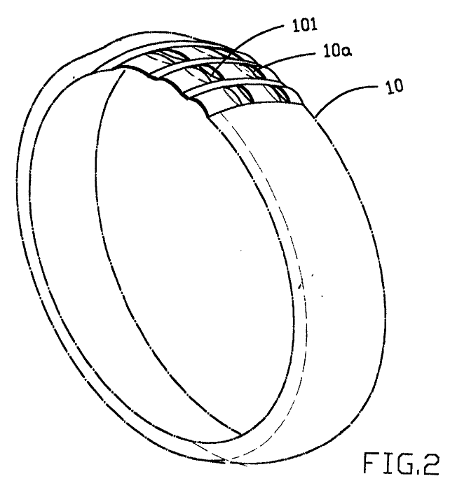

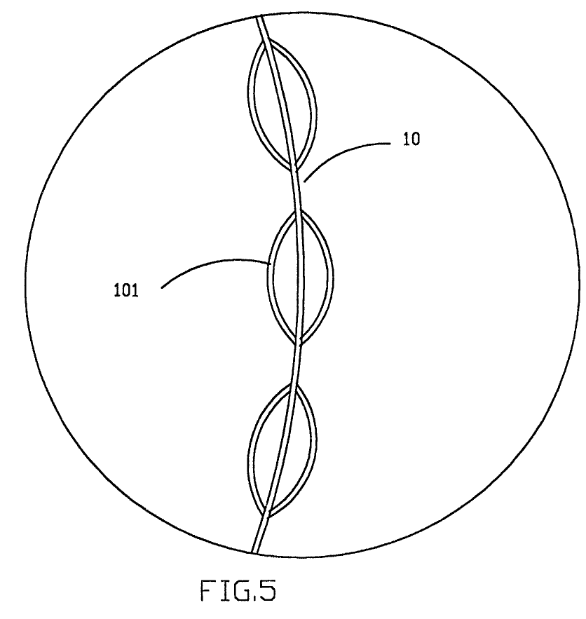

Referring to FIGS. 2, 3b, 3c, 3d, and 5, the tire breaker 10 comprises at least one series of through holes 10a arranged around the periphery, and a plurality of flaps 101 respectively protruded from the inner sidewall thereof around the through holes 10a. By means of the through holes 10a and the flaps 101, the tire breaker 10 can be expanded to fit the inner tube of the vehicle tire when the inner tube is inflated.

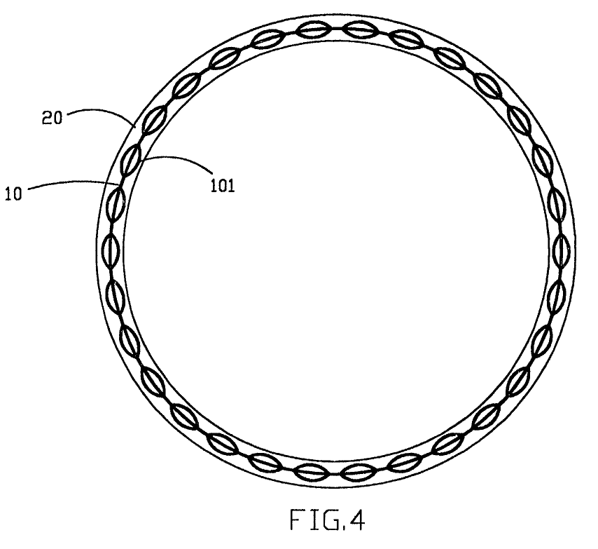

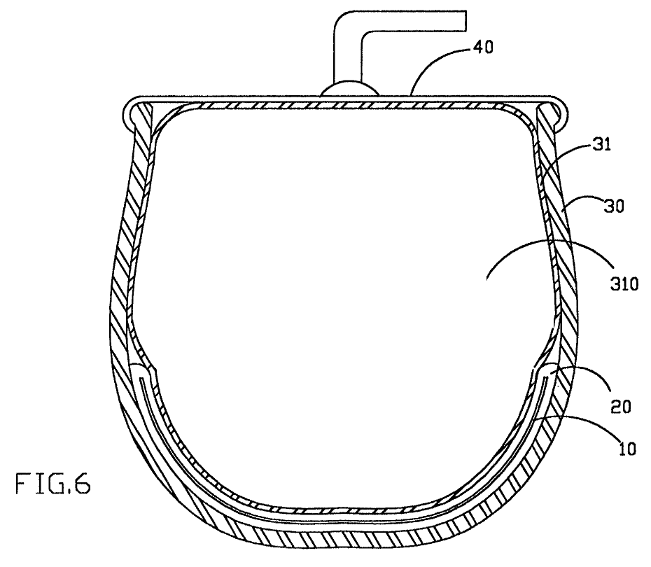

Referring to FIGS. 4 and 6, the tire breaker 10 is covered with a flexible covering 20, and then put around the inner tube 31 in the outer tire 30, which is fastened to the rim 40 of the vehicle tire. After installation, the inside space 310 of the inner tube 31 is filled up with air. After the inner tube 31 has been inflated, the flexible covering 20 and its inside tire breaker 10 are squeezed in between the outside wall of the inner tube 31 and the inside wall of the outer tire 30 to protect the inner tube 31 against piercing of external sharp objects.

The aforesaid tire breaker 10 can be directly embedded in the outer tire 30.

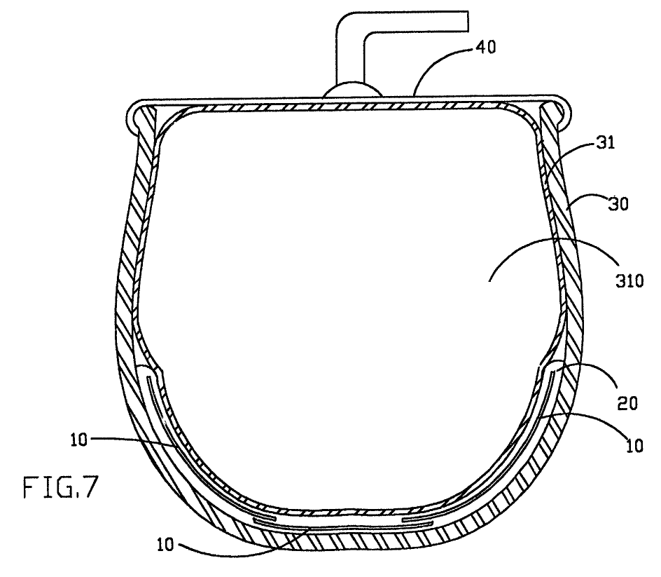

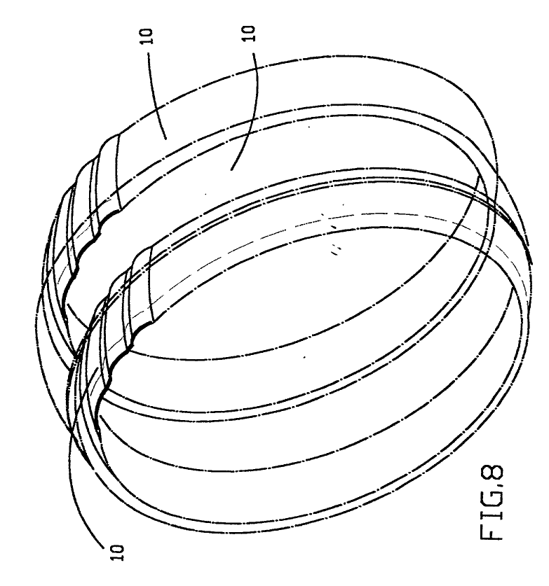

Referring to FIGS. 7 and 8, a plurality of tire breakers 10 may be arranged in parallel and partially peripherally overlapped on one another, and covered with a flexible covering 20.

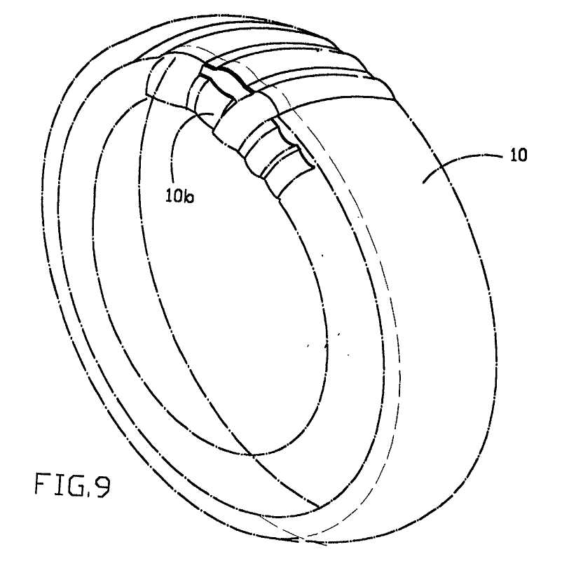

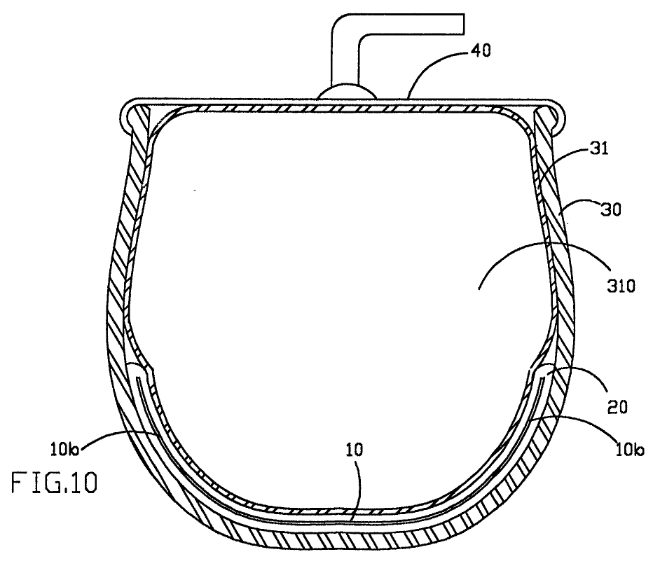

Referring to FIGS. 9 and 10, the tire breaker 10 is made having a plurality of side bendable side strips 10b respectively disposed at two sides around the center, and covered with a flexible covering 20.

A prototype of swivel lawn sprinkler has been constructed with the features of the annexed drawings. The swivel lawn sprinkler functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A tire breaker having an annular body fitting over the periphery of the inner tube of a vehicle tire and adapted to protect the inner tube of the vehicle tire against piercing of external sharp objects, said annular body having a corrugated outside wall.

2. The tire breaker of claim 1 wherein said annular body comprises at least one series of through holes arranged around the periphery thereof and a plurality of flaps respectively protruded from an inner sidewall thereof around said through holes.

3. The tire breaker of claim 1 further comprising a flexible covering covered on said annular body to hold said annular body in between the inner tube and outer tire of the vehicle tire.

4. The tire breaker of claim 1 wherein said annular body is embedded into the outer tire of the vehicle tire.

5. The tire breaker of claim 1, which is arranged in parallel with a plurality of tire breakers of same structure and covered within a flexible covering to protect the inner tube of the vehicle tire against piercing of external sharp objects.

6. The tire breaker of claim 1 wherein said annular body comprises a plurality of bendable side strips respectively disposed at two sides around the center thereof, and is covered with a flexible covering.
